(19) United States
(12) Patent Application Publication
(10) Pub. No.: US 2026/0296271 A1
(43) Pub. Date: Oct. 1, 2026

(54) VEHICLE INTERIOR COMPONENT CONTROL SYSTEM

(71) Applicant: HONDA MOTOR CO., LTD., Tokyo (JP)

(72) Inventors: Akira SAKATA, Tokyo (JP); Shogo USUI, Tokyo (JP); Koji HASHIMOTO, Tokyo (JP); Hiroki YAMADA, Tokyo (JP); Kazuya KANEKASU, Tokyo (JP)

(21) Appl. No.: 19/630,984

(22) Filed: Mar. 27, 2026

(30) Foreign Application Priority Data
Mar. 31, 2025 (JP) 2025-058859

(51) Int. Cl. B60N 2/02; B60N 2/06; B62D 1/183

(52) U.S. Cl. CPC B60N 2/0256; B60N 2/06; B62D 1/183

(57) ABSTRACT

A vehicle interior component control system includes: a vehicle interior component switchable among a driving-state, a boarding/alighting-state, and a standby-state; a controller configured to control the vehicle interior component; and a door sensor configured to detect opening and closing of a door. When the vehicle interior component is in the boarding/alighting-state and it is detected that a door main body has been closed, the controller switches the vehicle interior component to the standby-state. When the vehicle interior component is in the standby-state and it is detected that the door main body has been opened, the controller switches the vehicle interior component to the boarding/alighting-state.

### REFERENCE TO RELATED APPLICATIONS

The present invention relates to and asserts priority from Japanese patent application No. 2025-058859 filed on Mar. 31, 2025, and incorporates the entirety of the contents and subject matter of all the above application herein by reference.

### BACKGROUND OF THE INVENTION

### Technical Field

The present invention relates to technologies for controlling a vehicle interior component in a cabin of a vehicle.

### Background Art

In recent years, initiatives have intensified to provide access to sustainable transportation systems that consider individuals in vulnerable positions among traffic participants, such as elderly individuals, persons with disabilities, and children. To realize this goal, research and development efforts have focused on enhancing traffic safety and convenience through developments for improving an ease of boarding/alighting in a vehicle.

Patent Literature 1 (Japanese Patent Application Publication No.: 2017-171175) describes technology that facilitates passenger boarding by allowing a passenger to sit in a seat positioned at an evacuated position at the time of boarding and then automatically moving the seat from the evacuated position to a driving position.

### SUMMARY OF THE INVENTION

In the technology described in Patent Literature 1, the seat moves directly from the evacuated position to the driving position, which may cause the passenger to feel discomfort.

The present invention has been made in view of the foregoing, and an object thereof is to provide a vehicle interior component control system capable of suitably supporting passenger boarding and thereby contributing to the development of sustainable transportation systems.

To solve the above problem, a vehicle interior component control system according to the present invention includes: a vehicle interior component that is switchable among a driving-state, a boarding/alighting state, and a standby-state; a controller configured to control the vehicle interior component; and a door sensor configured to detect opening and closing of a door; wherein the controller is configured to switch the vehicle interior component to the standby-state when it is detected that the door has been closed while the vehicle interior component is in the boarding/alighting state, and to switch the vehicle interior component to the boarding/alighting state when it is detected that the door has been opened while the vehicle interior component is in the standby-state.

According to the present invention, passenger boarding can be suitably supported, and the invention can thereby contribute to the development of sustainable transportation systems.

### BRIEF DESCRIPTION OF DRAWINGS

FIG. 1 is a plan view schematically illustrating a vehicle to which a vehicle interior component control system according to an embodiment of the present invention is applied.

FIG. 2 is a block diagram schematically illustrating the vehicle interior component control system according to the embodiment of the present invention.

FIG. 3 is a side view schematically illustrating a driving position, a boarding/alighting position, and a standby position of a seat according to the embodiment of the present invention.

FIG. 4 is a side view schematically illustrating a driving position, a boarding/alighting position, and a boarding/alighting presentation position of a steering wheel according to the embodiment of the present invention.

FIG. 5 is a representative sequence diagram illustrating operations of the vehicle interior component control system during boarding.

FIG. 6 is a representative sequence diagram illustrating operations of the vehicle interior component control system during alighting.

FIG. 7 is a block diagram schematically illustrating an example of the controller of the vehicle interior component control system.

### DESCRIPTION OF EMBODIMENTS

Next, embodiments of the present invention will be described in detail below with reference to the drawings as appropriate. Same components are denoted by same reference numerals, and duplicate descriptions will be omitted.

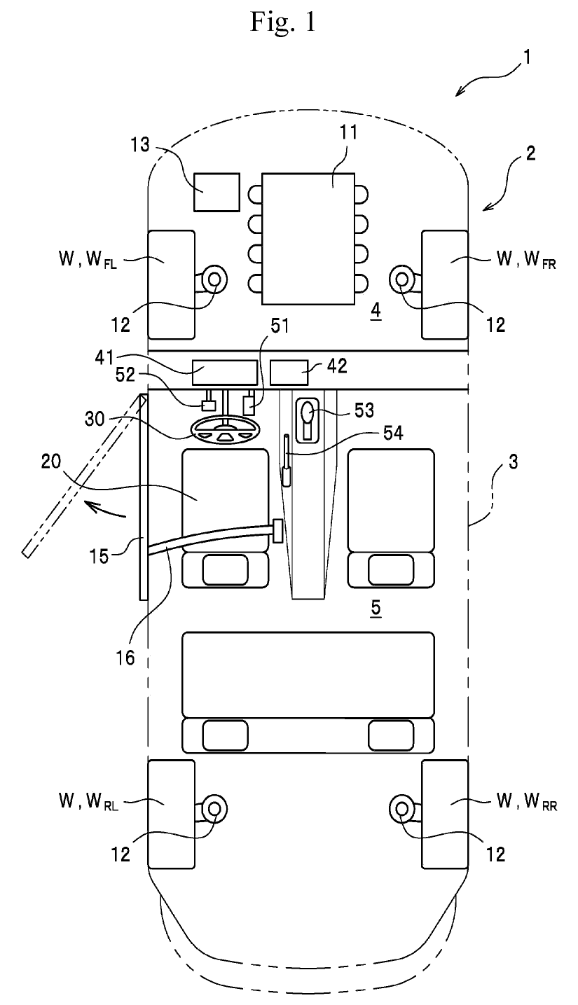

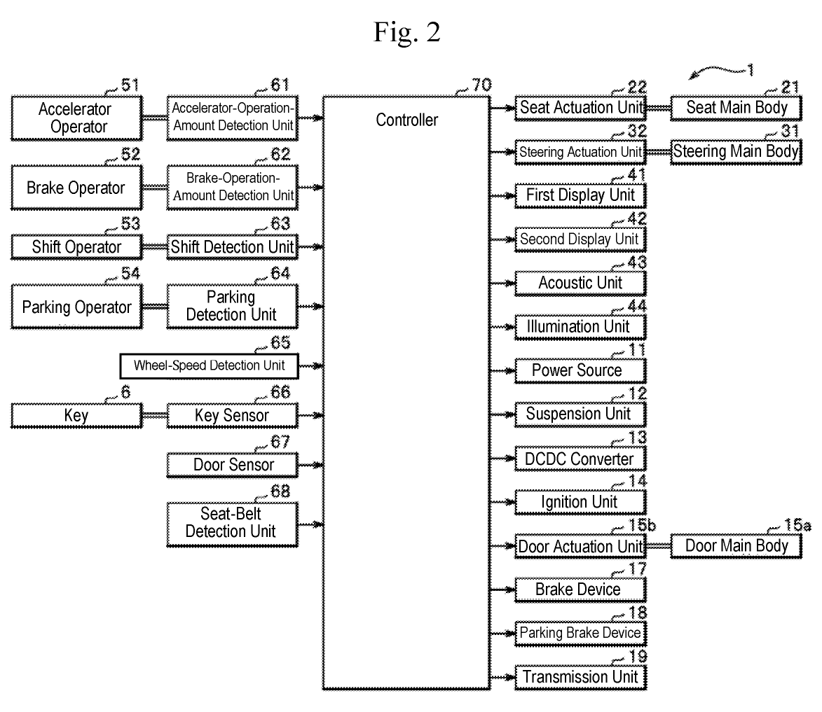

As shown in FIGS. 1 and 2, a vehicle interior component control system 1 according to the embodiment is a system for controlling vehicle interior components of a vehicle 2. The vehicle 2 includes a vehicle body 3 and wheels W (left front wheel W_{FL}, right front wheel W_{FR}, left rear wheel W_{RL}, and right rear wheel W_{RR}), and travels by rotating drive wheels among the wheels W with power generated by a power source 11.

The power source 11 is disposed in a power-source compartment 4 defined at a front portion of the vehicle body 3, and may be an internal combustion engine, an electric motor, or a hybrid of an internal combustion engine and an electric motor. The power source 11 generates power based on control signals from a controller 70 described later. The generated power is transmitted to the wheels W serving as drive wheels via a power transmission system (such as a transmission 19) not shown.

The vehicle 2 includes a suspension unit 12 that suspends each of the wheels W with respect to the vehicle body 3. The suspension unit 12 is configured to be capable of changing its vertical length (extension and retraction) based on control signals from the controller 70 described later.

The vehicle 2 includes a DCDC converter 13. The DCDC converter 13 converts electrical power stored in a battery (not shown) from direct current to direct current and supplies the converted power to electrical components of the vehicle 2, such as the vehicle interior components.

The vehicle 2 includes an ignition unit 14. The ignition unit 14 is a start-switch mechanism necessary to activate the power source 11. In the case of the power source 11 is an internal combustion engine, the ignition unit 14 is an ignition switch, and In the case of the power source 11 is an electric motor, the ignition unit 14 is a power source (power switch). When the ignition unit 14 is on, the electrical components of the vehicle 2 (including vehicle interior components) can be supplied with electrical power and are in an operable state. When the ignition unit 14 is off, the electrical components of the vehicle 2 (including vehicle interior components) cannot be supplied with electrical power and are in an inoperable state.

The vehicle interior component control system 1 includes, as vehicle interior components, a seat 20 and a steering wheel 30.

### Seat

The seat 20 is disposed in a cabin 5 and serves as a driver's seat on which a driver as a passenger sits. The seat 20 includes a seat main body 21 and a seat actuation unit 22.

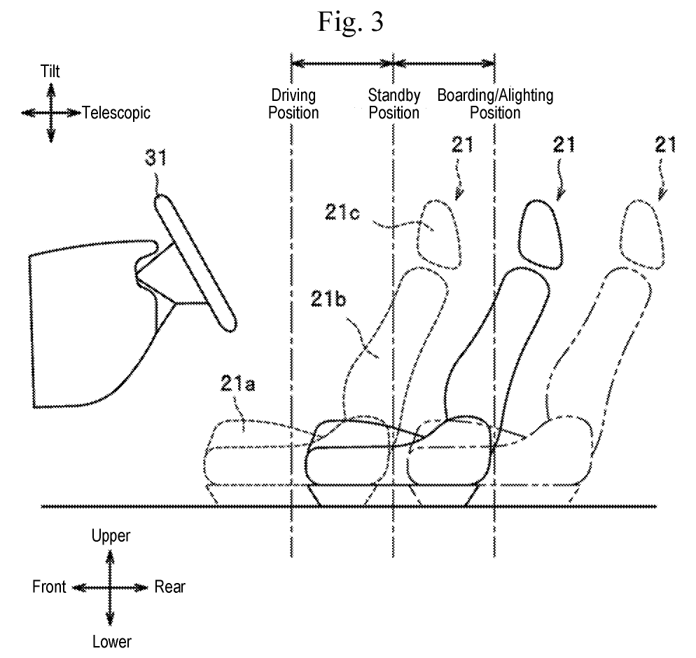

As shown in FIG. 3, the seat main body 21 includes: a seat cushion 21a on which a passenger can sit; a seatback 21b that extends upward from a rear end of the seat cushion 21a and corresponds to the passenger's back; and a headrest portion 21c that extends upward from an upper end of the seatback 21b and corresponds to the passenger's head.

As shown in FIG. 2, the seat actuation unit 22 includes a motor and a transmission mechanism configured to convert rotation of the motor into linear motion or the like, and moves the seat main body 21 in a front-and-rear direction and/or an upper-and-lower direction along slide rails disposed on a floor surface of the vehicle body 3. The seat actuation unit 22 may also be configured to tilt the seatback 21b forward or rearward relative to the seat cushion 21a, or to tilt the headrest portion 21c forward or rearward relative to the seatback 21b. Further, the seat actuation unit 22 may be configured to rotate the seat main body 21 about a vertical axis or to move the seat main body 21 laterally. Additionally, the seat actuation unit 22 may be configured to change the thickness of the seat cushion 21a, or to change the posture of an armrest (not shown).

### Steering

The steering wheel 30 includes a steering main body 31 and a steering actuation unit 32.

The steering main body 31 is disposed in front of the seat 20 serving as the driver's seat in the cabin 5, and is configured so that a driver can steer the wheels W serving as steerable wheels.

The steering actuation unit 32 includes a motor and a transmission mechanism that converts rotation of the motor into linear motion or the like, and moves the steering main body 31 in a front-and-rear direction. The steering actuation unit 32 additionally moves (in this embodiment, tilts) the steering main body 31 in an upper-and-lower direction.

The vehicle interior component control system 1 further includes, as vehicle interior components, a first display unit 41, a second display unit 42, an acoustic unit 43, and an illumination unit 44.

The first display unit 41 includes a display device and is positioned in front of the seat 20 serving as the driver's seat. The first display unit 41 is a so-called tachometer that displays information such as vehicle speed, rotational speed of the power source 11, and remaining fuel and/or battery power.

The second display unit 42 includes a touch-panel display or the like and is positioned toward the center in the vehicle width direction relative to the first display unit 41. The second display unit 42 displays maps of the surroundings of the vehicle 2.

The acoustic unit 43 includes a speaker or the like.

The illumination unit 44 includes LEDs or the like, and forms a line-shaped light source within the cabin 5.

The vehicle 2 to which the vehicle interior component control system 1 is applied includes an accelerator operator 51, a brake operator 52, a shift operator 53, and a parking operator 54.

The accelerator operator 51 is an operator (e.g., accelerator pedal) that the driver operates to activate the power source 11 and cause the vehicle 2 to travel (e.g., accelerate).

The brake operator 52 is an operator (e.g., brake pedal) that the driver operates to activate the brake device 17 and decelerate the vehicle 2.

The shift operator 53 is an operator (e.g., shift lever) that the driver operates to change the vehicle state (i.e., the state of the transmission unit 19), such as a drive range, neutral range, parking range, or reverse range.

In this embodiment, the shift operator 53 is an operator for changing the state of the transmission unit 19, which shifts output of the power source 11 in accordance with the state of the vehicle 2. Examples of transmission states include a drive range that allows forward travel, a reverse range that allows rearward travel, a parking range for parking the vehicle 2, and a neutral range that disconnects power transmission between the power source 11 and the drive wheels.

The parking operator 54 is an operator (e.g., lever or button) that the driver operates to activate or release the parking brake device 18. The parking operator 54 may be integrated with the shift operator 53.

The vehicle interior component control system 1 includes an accelerator‑operation‑amount detection unit 61, a brake‑operation‑amount detection unit 62, a shift detection unit 63, and a parking detection unit 64.

The accelerator‑operation‑amount detection unit 61 detects an amount of operation of the accelerator operator 51 by the passenger and outputs the detection result to the controller 70.

The brake-operation‑amount detection unit 62 detects an amount of operation of the brake operator 52 by the passenger and outputs the detection result to the controller 70.

The shift detection unit 63 detects an operation state (operation position) of the shift operator 53 by the passenger and outputs the detection result to the controller 70.

The parking detection unit 64 detects an operation state of the parking operator 54 by the passenger and outputs the detection result to the controller 70. The parking detection unit 64 may be integrated with the shift detection unit 63.

As shown in FIG. 2, the vehicle interior component control system 1 includes a wheel‑speed detection unit 65, a key sensor 66, a door sensor 67, and a seat-belt detection unit 68.

The wheel‑speed detection unit 65 detects the wheel speed (rotational speed) of the wheels W and outputs the detection result to the controller 70.

The key sensor 66 detects a key 6 of the vehicle 2 carried by a passenger and outputs the detection result to the controller 70. In this embodiment, the key sensor 66 detects whether the key 6 is outside the vehicle (outside the cabin 5) or inside the vehicle (inside the cabin 5). Here, the key 6 may be a digital key, FOB key, or mobile terminal using NFC, capable of communicating with the key sensor 66 (and the controller 70).

The door sensor 67 detects an open/closed state of a door 15 and outputs the detection result to the controller 70. In this embodiment, the door 15 is disposed at a position corresponding to the seat 20 serving as the driver's seat and includes a door main body 15a that can be opened or closed relative to the vehicle body 3, and a door actuation unit 15b configured to drive the door main body 15a based on control signals from the controller 70. The door actuation unit 15b includes a motor or the like.

The seat‑belt detection unit 68 detects an installation state of a seat-belt 16 and outputs the detection result to the controller 70. In the explanation below, "installation" of the seat-belt 16 refers to the seat-belt 16 being inserted into a buckle (detection result: from OFF to ON), and "removal" refers to the seat-belt 16 being removed from the buckle (detection result: from ON to OFF).

### Controller

The controller 70 is an ECU (Electronic Controller) includes a CPU (Central Processing Unit), ROM (Read‑Only Memory), RAM (Random Access Memory), input/output circuits, and the like. The controller 70 calculates vehicle speed based on detection results of the wheel‑speed detection unit 65. The controller 70 controls the power source 11 based on detection results of the accelerator‑operation‑amount detection unit 61. The controller 70 controls the brake device 17 of the vehicle 2 based on detection results of the brake‑operation‑amount detection unit 62 and applies braking force to the wheels W. The controller 70 performs on/off control of the parking brake device 18 of the vehicle 2 based on detection results of the parking detection unit 64 (or detection results of the shift detection unit 63). In this embodiment, the parking brake device 18 is electrically operated. The controller 70 is capable of controlling the door actuation unit 15b even when the ignition unit 14 is in an off state.

The controller 70 controls the vehicle interior components based on detection results from various detection units and switches states of the interior components among a driving-state, a boarding/alighting state, and a standby-state (or a boarding/alighting presentation state). Examples of vehicle interior components include the seat 20, the steering wheel 30, the first display unit 41, the second display unit 42, the acoustic unit 43, and the illumination unit 44. The following sections mainly describe state (position) control of the seat 20 and the steering wheel 30, followed by representative operational examples during boarding and alighting, which include explanations of state control of the first display unit 41, second display unit 42, acoustic unit 43, illumination unit 44, and suspension unit 12.

The driving-state is a state (including a position and/or posture) suitable for a passenger (driver) to operate the vehicle 2.

The boarding/alighting state is a state (including a position and/or posture) suitable for a passenger to board or alight from the vehicle 2 (and in cases where a boarding/alighting presentation state is present, the boarding/alighting state is particularly suitable for alighting).

The boarding/alighting presentation state is a state (including a position and/or posture) suitable for a passenger to board the vehicle 2.

The standby-state is a state in which the system waits for a passenger to board the vehicle 2, and is a state (including a position and/or posture) configured to provide an appropriate presentation for boarding through a transition from the standby-state to the boarding/alighting state or the boarding/alighting presentation state.

### Examples of seat state

The controller 70 switches the state of the seat 20, which is one example of a vehicle interior component, among the driving-state, the boarding/alighting state, and the standby-state. In this embodiment, the controller 70 controls the seat actuation unit 22 to move the seat main body 21 to one of a driving position, a boarding/alighting position, or a standby position.

### Driving Position

As shown in FIG. 3, the driving position is a position suitable for a passenger seated on the seat main body 21 to operate the vehicle 2, and is the most forward and/or upward position among the three positions.

### Boarding/Alighting Position

The boarding/alighting position is a position suitable for a passenger to board or alight from the seat main body 21, and is positioned rearward (e.g., 55 mm rearward) and/or downward relative to the driving position. When the seat main body 21 is in the boarding/alighting position, the space between the seat main body 21 and the steering main body 31, that is, the space in which the passenger can exist, is relatively large, thereby facilitating comfortable boarding and alighting for the passenger.

### Standby Position

The standby position is a position in which the seat main body 21 waits when no passenger is seated, and is different from both the driving position and the boarding/alighting position. In this embodiment, the standby position is rearward (e.g., 20 mm rearward) and/or downward relative to the driving position, and forward (e.g., 35 mm forward) and/or upward relative to the boarding/alighting position. The standby position is set between the driving position and the boarding/alighting position. That is, the distance between the standby position and the boarding/alighting position is shorter than the distance between the standby position and the driving position.

The controller 70 may set the driving position of the seat main body 21 based on a learned result of the seat position during driving, and may set the boarding/alighting position and the standby position corresponding to the learned driving position. Alternatively, the controller 70 may set the boarding/alighting position of the seat main body 21 as a fixed position, for example, a rearward and/or downward limit of travel of the seat main body 21. Further, the controller 70 may set the standby position rearward and/or downward relative to the boarding/alighting position.

The controller 70 may switch the posture (angle) about a vertical axis and/or the lateral position of the seat main body 21 as the driving-state (driving position), boarding/alighting state (boarding/alighting position), or standby-state (standby position). The controller 70 may also switch the thickness of the seat cushion 21a, or the posture (angle) of the seatback 21b, the headrest portion 21c, and/or an armrest (not shown) as the driving-state, boarding/alighting state, or standby-state.

The controller 70 may perform the same type of control for seats other than the driver's seat (e.g., passenger seats, rear seats). For boarding control of the rear seats, the controller 70 may move the front seat (passenger seat) forward or tilt the seatback 21b of the front seat forward to create an evacuated state (evacuated position) for the rear seat to facilitate boarding and alighting.

### Examples of steering state

As shown in FIG. 2, the controller 70 switches the state of the steering wheel 30 among a driving-state, a boarding/alighting-state (alighting-state), and a boarding/alighting presentation-state (boarding presentation-state). In this embodiment, the controller 70 moves the steering main body 31 to one of a driving position, a boarding/alighting position, or a boarding/alighting presentation position.

### Driving Position

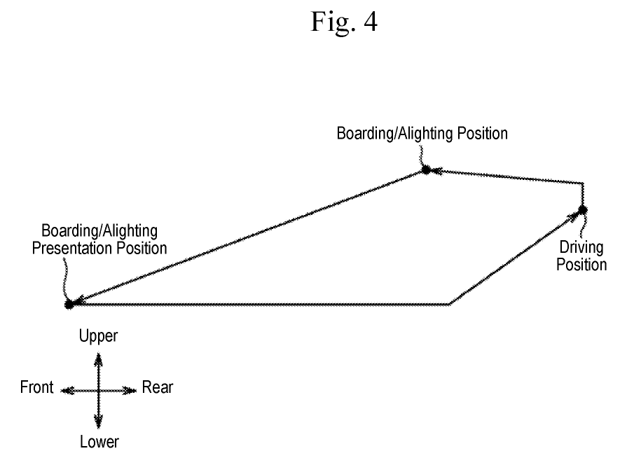

As shown in FIG. 4, the driving position is a position suitable for a passenger gripping the steering main body 31 to operate the vehicle 2, and is the most rearward position among the three positions.

### Boarding/Alighting Position (Alighting Position)

The boarding/alighting position is a position suitable for a passenger to board or alight (in this embodiment, to alight), and is positioned forward and/or upward relative to the driving position.

### Boarding/alighting Presentation Position (Boarding Presentation Position, Boarding Position

The boarding/alighting presentation position is a position for presenting boarding (in this embodiment, boarding) to the passenger, and is a position different from both the driving position and the boarding/alighting position. In this embodiment, the boarding/alighting presentation position is forward and/or downward relative to the boarding/alighting position.

As shown in FIG. 2, the controller 70 may set the driving position of the steering main body 31 based on a learned result of the steering position during driving, and may set the boarding/alighting position and the boarding/alighting presentation position corresponding to the learned driving position.

The controller 70 may be configured to fold the steering main body 31 or retract the steering main body 31 into the instrument panel as the driving-state (driving position), boarding/alighting state (boarding/alighting position), or boarding/alighting presentation state (boarding/alighting presentation position).

In a modified example, a standby position may be set for the steering main body 31 in the same manner as for the seat main body 21. For the steering main body 31, the standby position is positioned forward and/or upward from the driving position, and rearward and/or downward from the boarding/alighting position. The standby position is set between the driving position and the boarding/alighting position. That is, the distance between the standby position and the boarding/alighting position is shorter than the distance between the standby position and the driving position.

### Operation of Seat Main Body: Driving Position → Boarding/Alighting Position

First, movement of the seat main body 21 from the driving position to the boarding/alighting position in a state where the passenger is seated will be described (see FIG. 3 as needed).

When the seat main body 21 is in the driving position and removal of the seat-belt 16 is detected by the seat‑belt detection unit 68, the controller 70 moves the seat main body 21 to the boarding/alighting position.

When the vehicle speed is greater than a predetermined speed (e.g., 0 km/h or 5 km/h), the controller 70 prohibits movement of the seat main body 21 from the driving position to the boarding/alighting position. That is, when the seat main body 21 is in the driving position and the vehicle speed is equal to or lower than a predetermined speed (e.g., 0 km/h or 5 km/h), and when removal of the seat-belt 16 is detected by the seat‑belt detection unit 68, the controller 70 moves the seat main body 21 to the boarding/alighting position.

When the shift detection unit 63 detects that the shift operator 53 is in a range other than the parking range (or, likewise, when the transmission unit 19 is in a range other than the parking range), the controller 70 prohibits movement of the seat main body 21 from the driving position to the boarding/alighting position. That is, when the seat main body 21 is positioned in the driving position, and when the shift detection unit 63 detects that the shift operator 53 is in the parking range (or that the transmission unit 19 is in the parking range), and further when the seat‑belt detection unit 68 detects removal of the seat-belt 16, the controller 70 moves the seat main body 21 to the boarding/alighting position.

In this embodiment, when removal of the seat-belt 16 is detected, the vehicle speed is equal to or lower than a predetermined speed, and the shift operator 53 is in the parking range, the controller 70 moves the seat main body 21 from the driving position to the boarding/alighting position.

### Operation of Steering Main Body: Driving Position to Boarding/Alighting Position

Next, movement of the steering main body 31 from the driving position to the boarding/alighting position when a passenger is seated will be described (see FIG. 4 as appropriate).

When the steering main body 31 is positioned in the driving position and removal of the seat-belt 16 is detected by the seat‑belt detection unit 68, the controller 70 moves the steering main body 31 to the boarding/alighting position.

When the vehicle speed is greater than a predetermined speed (e.g., 0 km/h or 5 km/h), the controller 70 prohibits movement of the steering main body 31 from the driving position to the boarding/alighting position. That is, when the steering main body 31 is positioned in the driving position, and the vehicle speed is equal to or lower than a predetermined speed (e.g., 0 km/h or 5 km/h), and removal of the seat-belt 16 is detected by the seat‑belt detection unit 68, the controller 70 moves the steering main body 31 to the boarding/alighting position.

When the shift detection unit 63 detects that the shift operator 53 is in a range other than the parking range, the controller 70 prohibits movement of the steering main body 31 from the driving position to the boarding/alighting position. That is, when the steering main body 31 is positioned in the driving position, and when the shift detection unit 63 detects that the shift operator 53 is in the parking range, and removal of the seat-belt 16 is detected by the seat‑belt detection unit 68, the controller 70 moves the steering main body 31 to the boarding/alighting position.

In this embodiment, when removal of the seat-belt 16 is detected, the vehicle speed is equal to or lower than a predetermined speed, and the shift operator 53 is in the parking range, the controller 70 moves the steering main body 31 from the driving position to the boarding/alighting position.

Accordingly, the vehicle interior component control system 1 can support comfortable alighting by positioning both the seat main body 21 and the steering main body 31 in the boarding/alighting position.

Furthermore, because the system begins moving the seat main body 21 based on removal of the seat-belt 16 before the door 15 is opened, the system can quickly establish a state suitable for alighting.

### Operation of Seat Main Body: Boarding/Alighting Position to Standby Position

Next, movement of the seat main body 21 from the boarding/alighting position to the standby position after the passenger has alighted from the vehicle will be described (see FIG. 3 as appropriate).

When the seat main body 21 is positioned in the boarding/alighting position and the door sensor 67 detects that the door 15 has been closed, the controller 70 moves the seat main body 21 to the standby position.

When the key sensor 66 detects that the key 6 is inside the cabin 5, the controller 70 prohibits movement of the seat main body 21 from the boarding/alighting position to the standby position. That is, when the seat main body 21 is positioned in the boarding/alighting position, and the key sensor 66 detects that the key 6 is outside the cabin 5, and the door sensor 67 detects that the door 15 has been closed, the controller 70 moves the seat main body 21 to the standby position.

When the ignition unit 14 is detected to be on, the controller 70 prohibits movement of the seat main body 21 from the boarding/alighting position to the standby position. That is, when the seat main body 21 is positioned in the boarding/alighting position, and the ignition unit 14 is detected to be off, and the door sensor 67 detects that the door 15 has been closed, the controller 70 moves the seat main body 21 to the standby position.

In this embodiment, when performing the above control, the controller 70 turns on the ignition unit 14 when the key sensor 66 detects that the key 6 is inside the cabin 5, and turns off the ignition unit 14 when the key sensor 66 detects that the key 6 is outside the cabin 5.

Accordingly, the vehicle interior component control system 1 enables a pre‑boarding presentation operation by keeping the seat main body 21 in the standby position.

In a modified example, the controller 70 may move the steering main body 31 from the boarding/alighting position to the standby position in the same manner as the seat main body 21. In this case, the controller 70 moves the steering main body 31 at the same timing as the seat main body 21.

### Operation of Seat Main Body: Standby Position to Boarding/Alighting Position

Next, movement of the seat main body 21 from the standby position to the boarding/alighting position after the passenger has alighted from the vehicle will be described (see FIG. 3 as appropriate).

When the seat main body 21 is positioned in the standby position and the door sensor 67 detects that the door 15 has been opened, the controller 70 moves the seat main body 21 to the boarding/alighting position.

### Operation of Steering Main Body: Boarding/Alighting Position to Boarding/Alighting Presentation Position

Next, movement of the steering main body 31 from the boarding/alighting position to the boarding/alighting presentation position after the passenger has alighted from the vehicle will be described (see FIG. 4 as appropriate).

When the steering main body 31 is positioned in the boarding/alighting position and the door sensor 67 detects that the door 15 has been opened, the controller 70 moves the steering main body 31 to the boarding/alighting presentation position.

When the key sensor 66 detects that the key 6 is inside the cabin 5, the controller 70 prohibits movement of the steering main body 31 from the boarding/alighting position to the boarding/alighting presentation position. That is, when the steering main body 31 is positioned in the boarding/alighting position, and the key sensor 66 detects that the key 6 is outside the cabin 5, and the door sensor 67 detects that the door 15 has been opened, the controller 70 moves the steering main body 31 to the boarding/alighting presentation position.

When the ignition unit 14 is detected to be on, the controller 70 prohibits movement of the steering main body 31 from the boarding/alighting position to the boarding/alighting presentation position. That is, when the steering main body 31 is positioned in the boarding/alighting position, and the ignition unit 14 is detected to be off, and the door sensor 67 detects that the door 15 has been opened, the controller 70 moves the steering main body 31 to the boarding/alighting presentation position.

In this embodiment, when performing the above control, the controller 70 turns on the ignition unit 14 when the key sensor 66 detects that the key is inside the cabin 5, and turns off the ignition unit 14 when the key sensor 66 detects that the key is outside the cabin 5.

Accordingly, when the seat main body 21 is positioned in the boarding/alighting position and the steering main body 31 is positioned in the boarding/alighting presentation position, the passenger can comfortably board the vehicle.

Furthermore, by observing the movement of the seat main body 21 from the standby position to the boarding/alighting position, and the movement of the steering main body 31 from the boarding/alighting position to the boarding/alighting presentation position before boarding, the passenger can readily anticipate subsequent movement of the seat main body 21 and the steering main body 31 to the driving position after boarding.

### Operation of Steering Main Body: Boarding/alighting Presentation Position to Driving Position

Next, movement of the steering main body 31 from the boarding/alighting presentation position to the driving position when the passenger is seated will be described (see FIG. 4 as appropriate).

When the steering main body 31 is positioned in the boarding/alighting presentation position and the door sensor 67 detects that the door 15 has been closed, the controller 70 moves the steering main body 31 to the driving position.

When the key sensor 66 detects that the key 6 is outside the cabin 5, the controller 70 prohibits movement of the steering main body 31 from the boarding/alighting presentation position to the driving position. That is, when the steering main body 31 is positioned in the boarding/alighting presentation position, and the key sensor 66 detects that the key 6 is inside the cabin 5, and the door sensor 67 detects that the door 15 has been closed, the controller 70 moves the steering main body 31 to the driving position.

When the ignition unit 14 is detected to be off, the controller 70 prohibits movement of the steering main body 31 from the boarding/alighting presentation position to the driving position. That is, when the steering main body 31 is positioned in the boarding/alighting presentation position, and the ignition unit 14 is detected to be on, and the door sensor 67 detects that the door 15 has been closed, the controller 70 moves the steering main body 31 to the driving position.

In this embodiment, the controller 70 turns on the ignition unit 14 when the key sensor 66 detects that the key is inside the cabin 5, and turns off the ignition unit 14 when the key sensor 66 detects that the key is outside the cabin 5.

### Operation of Seat Main Body: Boarding/Alighting Position to Driving Position

Next, movement of the seat main body 21 from the boarding/alighting position to the driving position when the passenger is seated will be described (see FIG. 3 as appropriate).

When the seat main body 21 is positioned in the boarding/alighting position and installation of the seat-belt 16 is detected by the seat‑belt detection unit 68, the controller 70 moves the seat main body 21 to the driving position.

When the vehicle speed exceeds a predetermined speed (e.g., 5 km/h), the controller 70 prohibits movement of the seat main body 21 from the boarding/alighting position to the driving position.

That is, when the seat main body 21 is positioned in the boarding/alighting position, and the vehicle speed is equal to or lower than a predetermined speed (e.g., 5 km/h), and fastening of the seat-belt 16 is detected by the seat‑belt detection unit 68, the controller 70 moves the seat main body 21 to the driving position.

When the shift detection unit 63 detects that the shift operator 53 is in a range other than the parking range, the controller 70 prohibits movement of the seat main body 21 from the boarding/alighting position to the driving position.

That is, when the seat main body 21 is positioned in the boarding/alighting position, and the shift detection unit 63 detects that the shift operator 53 is in the parking range, and installation of the seat-belt 16 is detected by the seat‑belt detection unit 68, the controller 70 moves the seat main body 21 to the driving position.

When the ignition unit 14 is off, the controller 70 prohibits movement of the seat main body 21 from the boarding/alighting position to the driving position.

That is, when the seat main body 21 is positioned in the boarding/alighting position, and the ignition unit 14 is detected to be on, and installation of the seat-belt 16 is detected by the seat‑belt detection unit 68, the controller 70 moves the seat main body 21 to the driving position.

In this embodiment, when fastening of the seat-belt 16 is detected, the vehicle speed is equal to or lower than the predetermined speed, the shift operator 53 is in the parking range, and the ignition unit 14 is on, the controller 70 moves the seat main body 21 from the boarding/alighting position to the driving position.

### Representative Operation Example during Boarding

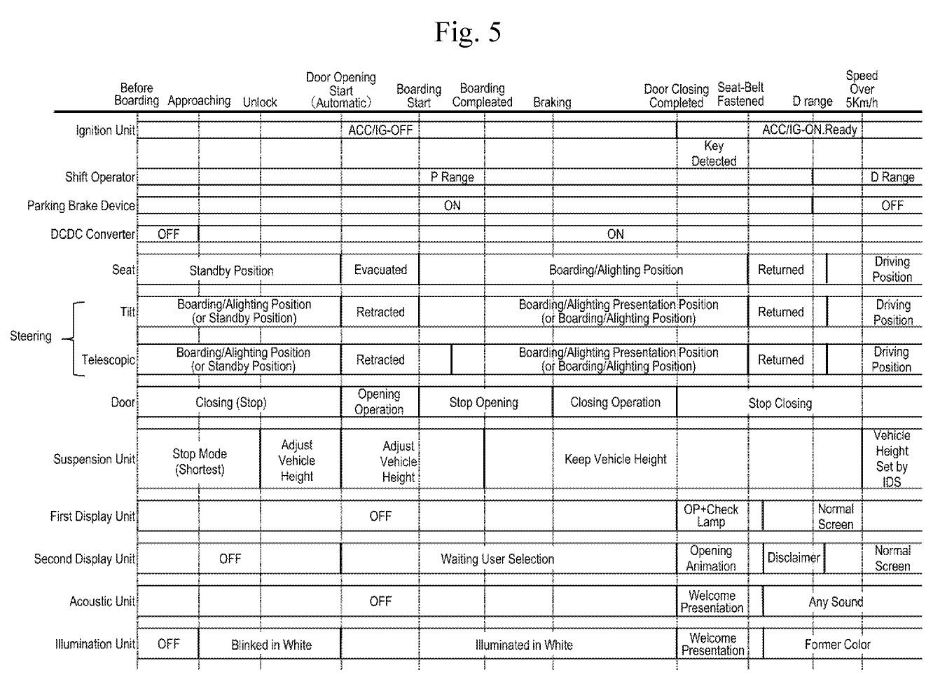

Next, a representative operation example during boarding will be described (see FIG. 5 as appropriate). When a driver located outside the cabin 5 approaches the vehicle 2, the key sensor 66 detects the key 6 carried by the driver. Based on this detection result, the controller 70 switches the DC–DC converter 13 from off to on. The controller 70 also causes the illumination unit 44 to blink in white based on the detection result.

Next, based on the detection result, the controller 70 unlocks the door 15 and extends the suspension unit 12. That is, the controller 70 raises the vehicle height and activates lighting to provide a welcome presentation to the passenger.

Next, the controller 70 automatically opens the door 15. Here, the controller 70 switches the seat 20 from the standby-state to the boarding/alighting state, that is, moves the seat main body 21 from the standby position to the boarding/alighting position. The controller 70 also switches the steering wheel 30 from the boarding/alighting state (or standby-state) to the boarding/alighting presentation state (or boarding/alighting state), that is, moves the steering main body 31 from the boarding/alighting position (or standby position) to the boarding/alighting presentation position (or boarding/alighting position).

In addition, the controller 70 further extends the suspension unit 12. The controller 70 also turns on the illumination unit 44 in white.

In this state, the passenger boards the vehicle 2 and sits on the seat main body 21. After boarding is completed, the passenger operates the brake operator 52. The brake‑operation‑amount detection unit 62 detects the operation.

Based on the detection result of the brake‑operation‑amount detection unit 62, the controller 70 automatically closes the door 15.

After the door‑closing operation is completed, the controller 70 switches the ignition unit 14 from off to on. The controller 70 causes the first display unit 41 to display an opening animation and check lamps, followed by a normal screen. The controller 70 also causes the second display unit 42 to display an opening animation, followed by disclaimers, and then a normal screen. The controller 70 causes the acoustic unit 43 to output a welcome‑presentation sound effect, followed by an appropriate sound. The controller 70 also causes the illumination unit 44 to execute welcome‑presentation lighting or blinking, followed by lighting in a default color or the previous boarding color. That is, the controller 70 provides a welcome presentation and an operational opening presentation using vehicle height adjustment, light, sound, and animations.

Next, the passenger fastens the seat-belt 16. The seat‑belt detection unit 68 detects the fastening.

Based on the detection result of the seat‑belt detection unit 68, the controller 70 moves the seat main body 21 from the boarding/alighting position to the driving position, and moves the steering main body 31 from the boarding/alighting presentation position (or boarding/alighting position) to the driving position.

When the passenger shifts the shift operator 53 from the parking range to the drive range (where the parking brake device 18 is switched from on to off), and when the vehicle speed becomes greater than a predetermined speed (e.g., 5 km/h) as a result of operating the accelerator operator 51, the controller 70 adjusts the suspension unit 12 to a predetermined height.

### Representative Operation Example during Alighting

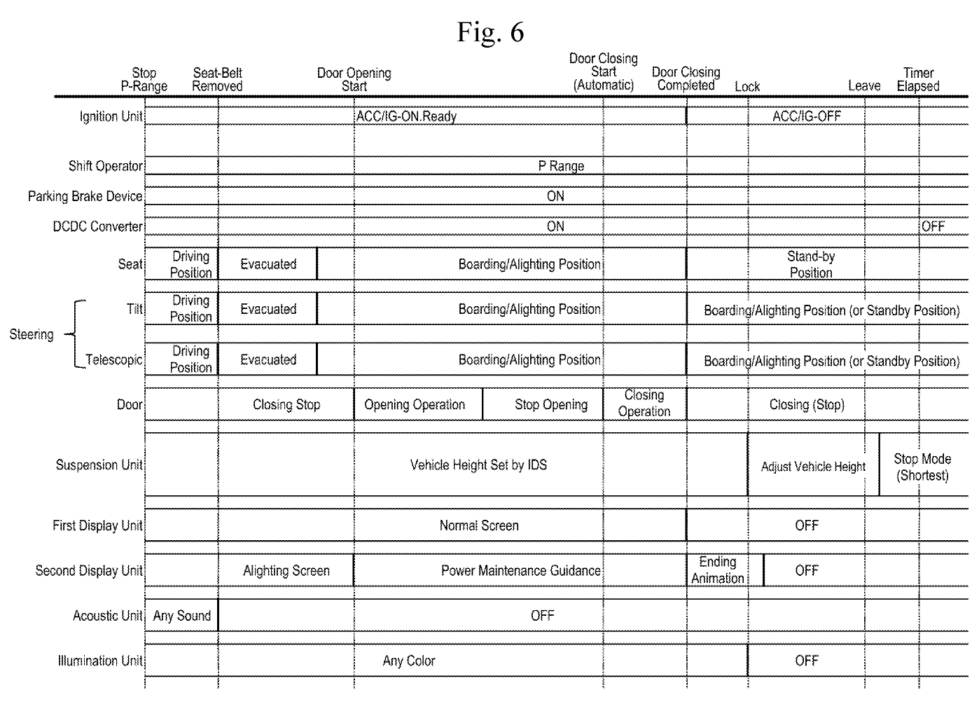

Next, a representative operation example during alighting will be described (see FIG. 6 as appropriate). The passenger stops the vehicle 2 by operating the brake operator 52 and shifts the shift operator 53 from the drive range to the parking range. The controller 70 causes the second display unit 42 to display an alighting screen.

Next, the passenger removes the seat-belt 16. The seat‑belt detection unit 68 detects the removal.

Based on the detection result of the seat‑belt detection unit 68, the controller 70 moves the seat main body 21 from the driving position to the boarding/alighting position and moves the steering main body 31 from the driving position to the boarding/alighting position. The controller 70 also turns off the acoustic unit 43.

Next, the passenger performs an operation instructing opening of the door 15 (e.g., operating a door‑open button or other operational component). The door sensor 67 detects the instruction.

Based on the detection result of the door sensor 67, the controller 70 automatically opens the door 15. The controller 70 also displays a power‑retention guidance screen on the second display unit 42 based on the detection result of the door sensor 67.

Here, because the key sensor 66 detects that the key 6 is inside the cabin 5, the controller 70 does not move the seat main body 21 from the boarding/alighting position to the standby position, nor move the steering main body 31 from the boarding/alighting position to the boarding/alighting presentation position. That is, the controller 70 maintains the seat main body 21 and the steering main body 31 in the boarding/alighting position. Accordingly, when the passenger does not actually alight after the door 15 opens (e.g., when a bicycle is approaching from behind and the passenger closes the door 15 again), the system prevents unintended movement of the vehicle interior components.

In this state, the passenger alights. The key sensor 66 detects the key 6 carried by the passenger.

Based on the detection result (indicating that the key is outside the cabin 5), the controller 70 closes the door 15. The door sensor 67 detects that the door 15 is closed.

Based on the detection result, the controller 70 moves the seat main body 21 from the boarding/alighting position to the standby position. The controller 70 either maintains the steering main body 31 in the boarding/alighting position or moves it from the boarding/alighting position to the standby position based on the detection result. The controller 70 turns off the first display unit 41 based on the detection result. The controller 70 causes the second display unit 42 to display an ending animation, followed by turning off the second display unit 42.

Next, the passenger performs a locking operation with the key 6. Based on the locking operation, the controller 70 retracts the suspension unit 12 to a stop mode. The controller 70 also turns off the illumination unit 44.

Next, the passenger leaves the vehicle 2. The key sensor 66 becomes unable to detect the key 6. After a predetermined time elapses from when the key sensor 66 becomes unable to detect the key 6, the controller 70 turns off the DCDC converter 13.

### Example of Controller

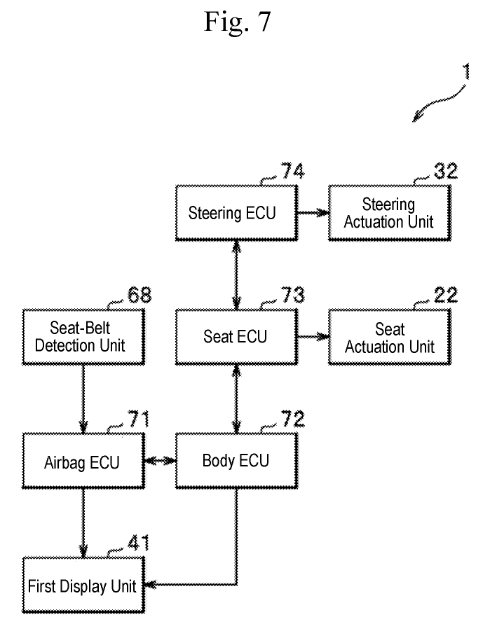

As shown in FIG. 7, the vehicle interior component control system 1 includes, as the controller 70 (see FIG. 2), an airbag ECU 71 configured to control an unillustrated airbag device, a body ECU 72 configured to control components of the vehicle body 3, a seat ECU 73 configured to control the seat actuation unit 22, and a steering ECU 74 configured to control the steering actuation unit 32.

The airbag ECU 71, the body ECU 72, and the first display unit 41 are communicably connected via CAN‑FD capable of relatively high‑speed communication.

The body ECU 72 and the seat ECU 73 are communicably connected via B‑CAN capable of relatively low‑speed communication.

The seat ECU 73 and the steering ECU 74 are communicably connected via LIN (Local Interconnect Network).

Detection results of the seat‑belt detection unit 68 are transmitted to the seat ECU 73 and the steering ECU 74 via the airbag ECU 71 and the body ECU 72. The airbag ECU 71 also causes the first display unit 41 to display detection results of the seat‑belt detection unit 68.

The vehicle interior component control system 1 according to the present embodiment includes a vehicle interior component that is switchable among a driving-state, a boarding/alighting state, and a standby-state, a controller 70 configured to control the vehicle interior component, and a door sensor 67 configured to detect opening and closing of a door 15. When the vehicle interior component is in the boarding/alighting state and the door 15 is detected to be closed, the controller 70 switches the component to the standby-state. When the component is in the standby-state and the door 15 is detected to be opened, the controller 70 switches the component to the boarding/alighting state.

Accordingly, the vehicle interior component control system 1 reduces passenger discomfort caused by state changes of interior components after boarding and can suitably support passenger boarding. The system also provides an uplifting boarding presentation beginning at the time the door 15 opens.

The driving-state corresponds to the driving position, the boarding/alighting state corresponds to the boarding/alighting position, and the standby-state corresponds to the standby position.

Accordingly, the vehicle interior component control system 1 reduces passenger discomfort caused by changes in the position of interior components after boarding and can suitably support passenger boarding.

The driving position and the standby position are different positions.

Accordingly, the vehicle interior component control system 1 can broaden the variety of boarding presentations provided to the passenger.

A distance between the standby position and the boarding/alighting position is shorter than a distance between the driving position and the boarding/alighting position.

Accordingly, the vehicle interior component control system 1 can achieve a boarding presentation without hindering passenger boarding by shortening the time required for movement from the standby position to the boarding/alighting position.

The vehicle interior component control system 1 includes the key sensor 66 configured to detect the key 6 of the vehicle 2, and when the key sensor 66 detects that the key 6 is inside the cabin, the controller 70 prohibits movement of the vehicle interior component from the boarding/alighting position to the standby position.

Accordingly, the vehicle interior component control system 1 can prevent unintended movement of the interior component while the passenger is inside the cabin, thereby preventing the passenger from feeling discomfort.

When the ignition is on, the controller 70 prohibits movement of the vehicle interior component from the boarding/alighting position to the standby position.

Accordingly, the vehicle interior component control system 1 can prevent unintended movement of the interior component while the passenger is inside the cabin, thereby preventing discomfort to the passenger.

The vehicle interior component control system 1 includes the key sensor 66 configured to detect the key 6 of the vehicle, and the controller 70 turns on the ignition when the key 6 is detected to be inside the cabin, and turns off the ignition when the key 6 is detected to be outside the cabin. Further, when the ignition is on, the controller 70 prohibits movement of the vehicle interior component from the boarding/alighting position to the standby position.

Accordingly, the vehicle interior component control system 1 can simplify passenger operations and can prevent unintended movement of the interior component while the passenger is inside the cabin, thereby preventing discomfort.

The vehicle interior component includes the seat 20.

Accordingly, the vehicle interior component control system 1 can support passenger boarding by reducing discomfort caused by changes in the seat state after boarding.

The seat 20 is movable in the front-and-rear direction and/or the upper-and-lower direction. The seat 20 in the boarding/alighting state is positioned rearward and/or downward relative to the seat 20 in the driving-state, and the seat 20 in the standby-state is positioned between the seat 20 in the boarding/alighting state and the seat 20 in the driving-state.

Accordingly, the vehicle interior component control system 1 can provide a presentation in which the seat is pulled during boarding. Further, the system can achieve the presentation without hindering boarding by shortening the time required for movement from the standby position to the boarding/alighting position.

The vehicle interior component includes the steering wheel 30.

Accordingly, the vehicle interior component control system 1 can support passenger boarding by reducing discomfort caused by changes in the state of the steering wheel 30 after boarding.

The steering wheel 30 is movable in the front-and-rear direction and/or the upper-and-lower direction. The steering wheel 30 in the boarding/alighting state is positioned forward and/or upward relative to the steering wheel 30 in the driving-state. The steering wheel 30 in the standby-state is positioned rearward and/or downward relative to the steering wheel 30 in the driving-state, and is positioned between the steering wheel 30 in the boarding/alighting state and the steering wheel 30 in the driving-state.

Accordingly, the vehicle interior component control system 1 can provide a presentation that expands the cabin space for the passenger during boarding.

Further, the system can achieve the presentation without hindering boarding by shortening the time required for movement of the steering wheel 30 from the boarding/alighting position to the standby position.

In the vehicle interior component control system 1 according to the embodiment of the present invention, the vehicle interior component is switchable between the driving-state and the boarding/alighting state, and the system includes the controller 70 and the door sensor 67 configured to detect opening and closing of the door 15. When the vehicle interior component is in the boarding/alighting state and the door 15 is detected to be opened, the controller 70 switches the vehicle interior component to the boarding/alighting presentation state.

Accordingly, the vehicle interior component control system 1 can reduce discomfort caused by changes in the state of interior components after boarding and can suitably support passenger boarding. Further, the system can provide an uplifting boarding presentation starting at the moment the door 15 is opened.

The driving-state corresponds to the driving position, the boarding/alighting state corresponds to the boarding/alighting position, and the boarding/alighting presentation state corresponds to the boarding/alighting presentation position.

Accordingly, the vehicle interior component control system 1 can reduce discomfort caused by changes in positions of interior components after boarding and can suitably support passenger boarding.

The vehicle interior component control system 1 includes the key sensor 66 configured to detect the key 6 of the vehicle 2, and when the key 6 is detected to be inside the cabin, the controller 70 prohibits movement of the vehicle interior component from the boarding/alighting position to the boarding/alighting presentation position.

Accordingly, the vehicle interior component control system 1 can prevent unintended movement of the interior component while the passenger is inside the cabin and thereby prevent discomfort to the passenger.

When the ignition is on, the controller 70 prohibits movement of the vehicle interior component from the boarding/alighting position to the boarding/alighting presentation position.

Accordingly, the vehicle interior component control system 1 can prevent unintended movement of the interior component while the passenger is inside the cabin and thereby prevent discomfort to the passenger.

The vehicle interior component control system 1 includes the key sensor 66 configured to detect the key 6 of the vehicle 2. When the key 6 is detected to be inside the cabin, the controller 70 turns on the ignition, and when the key 6 is detected to be outside the cabin, the controller 70 turns off the ignition. When the ignition is on, the controller 70 prohibits movement of the vehicle interior component from the boarding/alighting position to the boarding/alighting presentation position.

Accordingly, the vehicle interior component control system 1 can simplify passenger operations and can prevent unintended movement of the interior component while the passenger is inside the cabin, thereby preventing discomfort.

Although the embodiment of the present invention has been described above, the present invention is not limited to this embodiment and may be modified as appropriate without departing from the scope and spirit of the invention.

For example, the controller 70 of the vehicle interior component control system 1 may switch the accelerator operator 51 or the brake operator 52, as vehicle interior components, among the driving-state, the boarding/alighting state, and the standby-state (or a boarding/alighting presentation state).

### EXPLANATION OF REFERENCE NUMERALS

1 Vehicle interior component control system

15 Door

16 Seat-belt

20 Seat (vehicle interior component)

30 Steering wheel (vehicle interior component)

67 Door sensor

68 Seat‑belt detection unit

70 Controller

What is claimed is:

1. A vehicle interior component control system, comprising:
a vehicle interior component being switchable among a driving-state, a boarding/alighting-state, and a standby-state;
a controller configured to control the vehicle interior component; and
a door sensor configured to detect opening and closing of at least one door;
wherein the controller is configured to:
switch the vehicle interior component from the boarding/alighting-state to the standby-state in response to detection of a door-closed event when the vehicle interior component is in the boarding/alighting-state; and
switch the vehicle interior component from the standby-state to the boarding/alighting-state in response to detection of a door-open event when the vehicle interior component is in the standby-state.

2. The vehicle interior component control system according to claim 1, wherein the driving-state corresponds to a driving position, the boarding/alighting-state corresponds to a boarding/alighting position, and the standby-state corresponds to a standby position.

3. The vehicle interior component control system according to claim 2, wherein the driving position is different from the standby position.

4. The vehicle interior component control system according to claim 2, wherein a distance between the standby position and the boarding/alighting position is less than a distance between the driving position and the boarding/alighting position.

5. The vehicle interior component control system according to claim 2, further comprising a key sensor configured to detect a vehicle key,
wherein the controller is configured to inhibit movement of the vehicle interior component from the boarding/alighting position to the standby position when the vehicle key is detected to be inside a vehicle cabin.

6. The vehicle interior component control system according to claim 2, wherein the controller is configured to inhibit movement of the vehicle interior component from the boarding/alighting position to the standby position when an ignition is on.

7. The vehicle interior component control system according to claim 2, further comprising a key sensor configured to detect a vehicle key,
wherein the controller is configured to turn an ignition on when the vehicle key is detected inside a cabin and to turn the ignition off when the vehicle key is detected outside the cabin, and
wherein the controller is configured to inhibit movement of the vehicle interior component from the boarding/alighting position to the standby position when the ignition is on.

8. The vehicle interior component control system according to claim 1, wherein the vehicle interior component includes a seat.

9. The vehicle interior component control system according to claim 8, wherein the seat is movable in a front-and-rear direction and/or an upper-and-lower direction,
wherein the seat in the boarding/alighting-state is rearward and/or downward relative to the seat position in the driving-state, and
wherein the seat in the standby-state is positioned between the boarding/alighting-state seat and the driving-state seat.

10. The vehicle interior component control system according to claim 1, wherein the vehicle interior component includes a steering wheel.

11. The vehicle interior component control system according to claim 10, wherein the steering wheel is movable in a front-and-rear direction and/or an upper-and-lower direction,
wherein the steering wheel in the boarding/alighting-state is forward and/or upward relative to the steering wheel in the driving-state, and
wherein the steering wheel in the standby-state is positioned between steering positions in the boarding/alighting-state and the driving-state.

12. A vehicle interior component control system, comprising:
a vehicle interior component being switchable between a driving-state and a boarding/alighting-state;
a controller configured to control the vehicle interior component; and
a door sensor configured to detect opening and closing of a door;
wherein the controller is configured to switch the vehicle interior component to a boarding/alighting presentation-state in response to detection of a door-open event when the vehicle interior component is in the boarding/alighting-state.

13. The vehicle interior component control system according to claim 12, wherein the driving-state corresponds to a driving position, the boarding/alighting-state correspond to a boarding/alighting position, and the boarding/alighting presentation-state corresponds to a boarding/alighting presentation position.

14. The vehicle interior component control system according to claim 13, further comprising a key sensor configured to detect a vehicle key,
wherein the controller is configured to inhibit movement of the vehicle interior component from the boarding/alighting position to the boarding/alighting presentation position when the vehicle key is detected inside a cabin.

15. The vehicle interior component control system according to claim 13, wherein the controller is configured to inhibit movement of the vehicle interior component from the boarding/alighting position to the boarding/alighting presentation position when an ignition is on.

16. The vehicle interior component control system according to claim 13, further comprising a key sensor configured to detect a vehicle key,
wherein the controller is configured to turn an ignition on when the vehicle key is detected inside a cabin and to turn the ignition off when the vehicle key is detected outside the cabin, and
wherein the controller is configured to inhibit movement of the vehicle interior component from the boarding/alighting position to the boarding/alighting presentation position when the ignition is on.
